(19) United States
(12) Patent Application Publication
(10) Pub. No.: US 2021/0036833 A1
(43) Pub. Date: Feb. 4, 2021

(54) METHOD FOR DETERMINING CSI RESOURCE TYPE, TERMINAL AND NETWORK SIDE DEVICE

(71) Applicant: VIVO MOBILE COMMUNICATION CO.,LTD., Chang'an Dongguan, Guangdong (CN)

(72) Inventors: Xiaodong YANG, Chang'an Dongguan (CN); Yue MA, Chang'an Dongguan (CN)

(73) Assignee: VIVO MOBILE COMMUNICATION CO.,LTD., Chang'an Dongguan, Guangdong (CN)

(21) Appl. No.: 16/969,918

(22) PCT Filed: Jan. 22, 2019
(86) PCT No.: PCT/CN2019/072652

§ 371 Date: Aug. 13, 2020

(30) Foreign Application Priority Data
Feb. 13, 2018 (CN) 201810150949.8

(51) Int. Cl. H04L 5/00

(52) U.S. Cl. CPC H04L 5/0057; H04L 5/0048

(57) ABSTRACT

The present disclosure provides in some embodiments a method for determining a CSI resource type, a network side device and a terminal. The method for determining the CSI resource type is applied to the terminal, and includes: receiving an MAC CE for activating/deactivating CSI resource sets; and determining types of the CSI resource sets indicated in the MAC CE, the types of the CSI resource sets including a first type for the measurement of a semi-persistent PUCCH and a second type for the measurement of a semi-persistent PUSCH.

### CROSS-REFERENCE TO RELATED APPLICATION

The present application claims a priority of the Chinese patent application No. 201810150949.8 field on Feb. 13, 2018, which is incorporated herein by reference in its entirety.

### TECHNICAL FIELD

The present disclosure relates to the field of wireless communications technology, in particular to a method for determining a channel state information (Channel State Information, CSI) resource type, a terminal and a network side device.

### BACKGROUND

Channel state information-reference signal (Channel State Information-Reference Signal, CSI-RS) is used by a terminal to measure a downlink beam. One or more non-zero-power CSI-RS resource sets may be configured by a high layer for a user, and the actual quantity of the CSI-RS resource sets is configured at a network side.

Channel state information-interference measurement (Channel State Information-Interference measurement, CST-IM) is used by the terminal to measure interference. One or more CSI-IM resource sets may be configured by the high layer for the user. Transmission power for each CSI-IM configuration is assumed to be zero for the interference measurement.

Semi-persistent (Semi-Persistent, SP) CSI resource is activated/deactivated through a media access control control element (Media Access Control Control Element, MAC CE).

In the related art, a CSI measurement configuration structure has been presented. There are two types of semi-persistent measurement resources, i.e., a semi-persistent measurement resource for a physical uplink control channel (Physical Uplink Control Channel, PUCCH), and a semi-persistent measurement resource for a physical uplink shared channel (Physical Uplink Shared Channel, PUSCH). The CSI-RS resource sets and the CSI-IM resource sets may be configured for each type of the semi-persistent measurement resources. Each CSI-RS resource set includes one or more CSI-RS resources, and each CSI-IM resource set includes one or more CSI-IM resources.

When the above-mentioned CSI measurement configuration structure is adopted, it is impossible for the terminal to differentiate whether the CSI-RS resource set (or the CSI-IM resource set) indicated in the MAC CE is a CSI-RS resource set (or the CSI-IM resource set) configured for the semi-persistent PUCCH measurement resource or a CSI-RS resource set (or the CSI-IM resource set) configured for the semi-persistent PUSCH measurement resource. For example, when serial numbers of the CSI-RS resource sets configured for the semi-persistent PUCCH are 1, 2 and 3, serial numbers of the CSI-RS resource sets configured for the semi-persistent PUSCH are 1, 2, 3 and 4, and a serial number of a CSI-RS resource set carried in the MAC CE for activation is 2, it is impossible for the terminal to determine whether the CSI-RS resource configured for the semi-persistent PUCCH and having the serial number of 2, or the CSI-RS resource configured for the semi-persistent PUSCH and having the serial number of 2, is to be activated.

### SUMMARY

An object of the present disclosure is to provide a method for determining a CSI resource type, a terminal and a network side device, so as to solve the problem that it is impossible for the terminal to differentiate a type of a resource set indicated in the MAC CE.

In one aspect, the present disclosure provides in some embodiments a method for determining a CSI resource type, including: receiving an MAC CE for activating/deactivating CSI resource sets; and determining types of the CSI resource sets indicated in the MAC CE, the types of the CSI resource sets including a first type for the measurement of a semi-persistent PUCCH and a second type for the measurement of a semi-persistent PUSCH.

In another aspect, the present disclosure provides in some embodiments a method for activating/deactivating CSI resources for a network side device, including transmitting an MAC CE for activating/deactivating CSI resources to a terminal, and the MAC CE is used for the terminal to determine types of CSI resource sets indicated in the MAC CE upon the receipt of the MAC CE. The types of the CSI resource sets include a first type for the measurement of a semi-persistent PUCCH and a second type for the measurement of a semi-persistent PUSCH.

In yet another aspect, the present disclosure provides in some embodiments a terminal, including: a first reception module configured to receive an MAC CE for activating/deactivating CSI resource sets; and a determination module configured to determine types of the CSI resource sets indicated in the MAC CE, the types of the CSI resource sets including a first type for the measurement of a semi-persistent PUCCH and a second type for the measurement of a semi-persistent PUSCH.

In still yet another aspect, the present disclosure provides in some embodiments a network side device, including a first transmission module configured to transmit an MAC CE for activating/deactivating CSI resources to a terminal, and the MAC CE is used for the terminal to determine types of CSI resource sets indicated in the MAC CE upon the receipt of the MAC CE. The types of the CSI resource sets include a first type for the measurement of a semi-persistent PUCCH and a second type for the measurement of a semi-persistent PUSCH.

In still yet another aspect, the present disclosure provides in some embodiments a method for determining reference signal types of sounding reference signal (Sounding Reference Signal, SRS) resources for a terminal, including: receiving an MAC CE for activating/deactivating the SRS resources; and determining reference signal types of quasi-co-location (Quasi-Co-Location, QCL)-related information about SRS resource sets indicated in the MAC CE, the reference signal types including CSI-RS, synchronization signal block (Synchronization Signal Block, SSB) and SRS.

In still yet another aspect, the present disclosure provides in some embodiments a method for activating/deactivating SRS resources for a network side device, including transmitting an MAC CE for activating/deactivating the SRS resources to a terminal, and the MAC CE is used for the terminal to determine reference signal types of QCL-related information about SRS resource sets indicated in the MAC CE upon the receipt of the MAC CE. The reference signal types include CSI-RS, SSB and SRS.

In still yet another aspect, the present disclosure provides in some embodiments a terminal, including: a reception module configured to receive an MAC CE for activating/deactivating SRS resources; and a determination module configured to determine reference signal types of QCL-related information about SRS resource sets indicated in the MAC CE, the reference signal types including CSI-RS, SSB and SRS.

In still yet another aspect, the present disclosure provides in some embodiments a network side device, including a transmission module configured to transmit an MAC CE for activating/deactivating SRS resources to a terminal, and the MAC CE is used for the terminal to determine reference signal types of QCL-related information about SRS resource sets indicated in the MAC CE upon the receipt of the MAC CE. The reference signal types include CSI-RS, SSB and SRS.

In still yet another aspect, the present disclosure provides in some embodiments a terminal, including a processor, a memory, and a computer program stored in the memory and executed by the processor. The processor is configured to execute the computer program so as to implement the above-mentioned method for determining the CSI resource types, or implement the above-mentioned method for determining the reference signal types of the SRS resources.

In still yet another aspect, the present disclosure provides in some embodiments a network side device, including a processor, a memory, and a computer program stored in the memory and executed by the processor. The processor is configured to execute the computer program so as to implement the above-mentioned method for activating/deactivating the CSI resources, or implement the above-mentioned method for activating/deactivating the SRS resources.

In still yet another aspect, the present disclosure provides in some embodiments a computer-readable storage medium storing therein a computer program. The computer program is executed by a processor so as to implement the above-mentioned method for determining the CSI resource types, implement the above-mentioned method for activating/deactivating the CSI resources, implement the above-mentioned method for determining the reference signal types of the SRS resources, or implement the above-mentioned method for activating/deactivating the SRS resources.

According to the embodiments of the present disclosure, it is able to determine the types of the CSI resource sets indicated in the MAC CE for activating/deactivating the CSI resources, or determine the reference signal types of the SRS resources indicated in the MAC CE for activating/deactivating the SRS resources.

### BRIEF DESCRIPTION OF THE DRAWINGS

FIG. 1 is a flow chart of a method for determining a CSI resource type according to one embodiment of the present disclosure;

FIG. 2 is another flow chart of the method for determining the CSI resource type according to one embodiment of the present disclosure;

FIG. 3 is yet another flow chart of the method for determining the CSI resource type according to one embodiment of the present disclosure;

FIG. 4 is a schematic view showing contents in an MAC CE for activating/deactivating CSI resources according to one embodiment of the present disclosure;

FIG. 5 is a schematic view showing a header of the MAC CE for activating/deactivating the CSI resources according to one embodiment of the present disclosure;

FIG. 6 is still yet another flow chart of the method for determining the CSI resource type according to one embodiment of the present disclosure;

FIG. 7 is a flow chart of a method for activating/deactivating CSI resources according to one embodiment of the present disclosure;

FIG. 8 is a schematic view showing a terminal according to one embodiment of the present disclosure;

FIG. 9 is a schematic view showing a network side device according to one embodiment of the present disclosure;

FIG. 10 is a flow chart of a method for determining reference signal types of SRS resources according to one embodiment of the present disclosure;

FIGS. 11 to 14 are schematic view showings contents in an MAC CE for activating/deactivating the SRS resources according to one embodiment of the present disclosure;

FIG. 15 is a flow chart of a method for activating/deactivating SRS resources according to one embodiment of the present disclosure;

FIG. 16 is another schematic view showing the terminal according to one embodiment of the present disclosure;

FIG. 17 is another schematic view showing the network side device according to one embodiment of the present disclosure; and

FIG. 18 is yet another schematic view showing the terminal according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

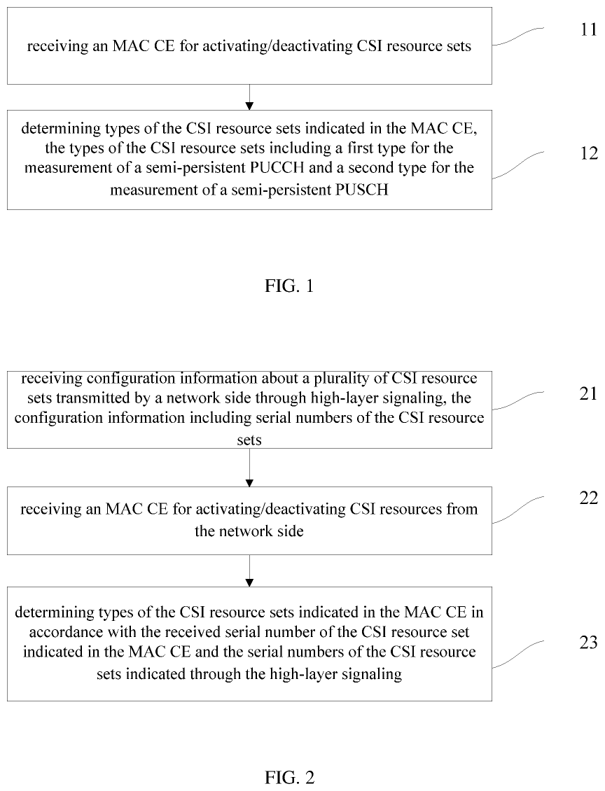

As shown in FIG. 1, the present disclosure provides in some embodiments a method for determining a CSI resource type for a terminal, including: Step 11 of receiving an MAC CE for activating/deactivating CSI resource sets; and Step 12 of determining types of the CSI resource sets indicated in the MAC CE. The types of the CSI resource sets include a first type for the measurement of a semi-persistent PUCCH and a second type for the measurement of a semi-persistent PUSCH.

In the embodiments of the present disclosure, an activated/deactivated state of at least one CSI resource set may be indicated in the MAC CE for activating/deactivating (activating or deactivating) the CSI resource sets, and each CSI resource set may include one or more CSI resources.

In the embodiments of the present disclosure, the first type of CSI resource sets may be used for the measurement of the semi-persistent PUCCH, and the second type of the CSI resource sets may be used for the measurement of the semi-persistent PUSCH.

In the embodiments of the present disclosure, the CSI resources may be CSI-RS resources or CSI-IM resources.

Merely an activated/deactivated state of a CSI-RS resource set or a CSI-IM resource set, or both of the activated/deactivated state of the CSI-RS resource set or the CSI-IM resource set, may be indicated in the MAC CE.

According to the embodiments of the present disclosure, upon the receipt of the MAC CE for activating/deactivating the CSI resource sets, it is able to determine the types of the CSI resource sets indicated in the MAC CE, thereby to solve the problem that it is impossible to differentiate the CSI resource set to be activated when a same serial number is used by the CSI resource set for the measurement of the semi-persistent PUCCH and the CSI resource set for the measurement of the semi-persistent PUSCH.

In the embodiments of the present disclosure, subsequent to determining the types of the CSI resource sets indicated in the MAC CE, the method may further include activating/deactivating a corresponding CSI resource set in accordance with the determined types of the CSI resource sets indicated in the MAC CE.

In the embodiments of the present disclosure, the types of the CSI resource sets indicated in the MAC CE may be determined in various ways, which will be illustratively described hereinafter.

As shown in FIG. 2, the present disclosure provides in some embodiments a method for determining a CSI resource type for a terminal, which includes the following steps.

Step 21: receiving configuration information about a plurality of CSI resource sets transmitted by a network side through high-layer signaling. The configuration information may include serial numbers of the CSI resource sets. The plurality of CSI resource sets may include a first type of CSI resource sets and a second type of CSI resource sets. In the serial numbers of the CSI resource sets, the CSI resource sets including different CSI resources may have different serial numbers.

Step 22: receiving an MAC CE for activating/deactivating CSI resources from the network side. A serial number of a CSI resource set to be activated/deactivated may be carried in the MAC CE.

Step 23: determining types of the CSI resource sets indicated in the MAC CE in accordance with the received serial number of the CSI resource set indicated in the MAC CE and the serial numbers of the CSI resource sets indicated through the high-layer signaling. The CSI resource set indicated in the MAC CE may use a same numbering method as the CSI resource sets indicated through the high-layer signaling.

In the embodiments of the present disclosure, CSI resource sets for the measurement of a semi-persistent PUCCH and CSI resource sets for the measurement of a semi-persistent PUSCH configured through the high-layer signaling may be numbered uniformly. For example, the quantity of CSI resource sets for the PUCCH may be 16 at most, and the quantity of CSI resource sets for the PUSCH may be 16 at most, so the CSI resource sets may be numbered from 0 to 31.

In some embodiments of the present disclosure, the serial numbers of the CSI resource sets for the PUCCH and the serial numbers of the CSI resource sets for the PUSCH configured through the high-layer signaling may be different from each other.

In some other embodiments of the present disclosure, in the CSI resource sets for the PUCCH and the CSI resource sets for the PUSCH configured through the high-layer signaling, the CSI resource sets including different CSI resources may have different serial numbers, and the CSI resource sets including same CSI resources may have a same serial number. For example, the serial numbers of the CSI resource sets for the PUCCH may be 1, 2 and 3, and the serial numbers of the CSI resource sets for the PUSCH may be 3, 25 and 28. The CSI resource sets for the PUCCH and the CSI resource sets for the PUSCH both includes the CSI resource set having a serial number of 3, and it means that the CSI resource sets having the serial number of 3 include the same CSI resources.

In addition, in the embodiments of the present disclosure, the CSI resource sets indicated in the MAC CE may use a same numbering method as the CSI resource sets indicated through the high-layer signaling. In other words, in the CSI resource sets indicated in the MAC CE and the CSI resource sets indicated through the high-layer signaling, the CSI resource sets including the same CSI resources may have a same serial number.

Hence, in the embodiments of the present disclosure, when the serial number of the CSI resource set to be activated/deactivated is carried in the MAC CE, the terminal may determine the CSI resource set to be activated/deactivated in accordance with the serial number.

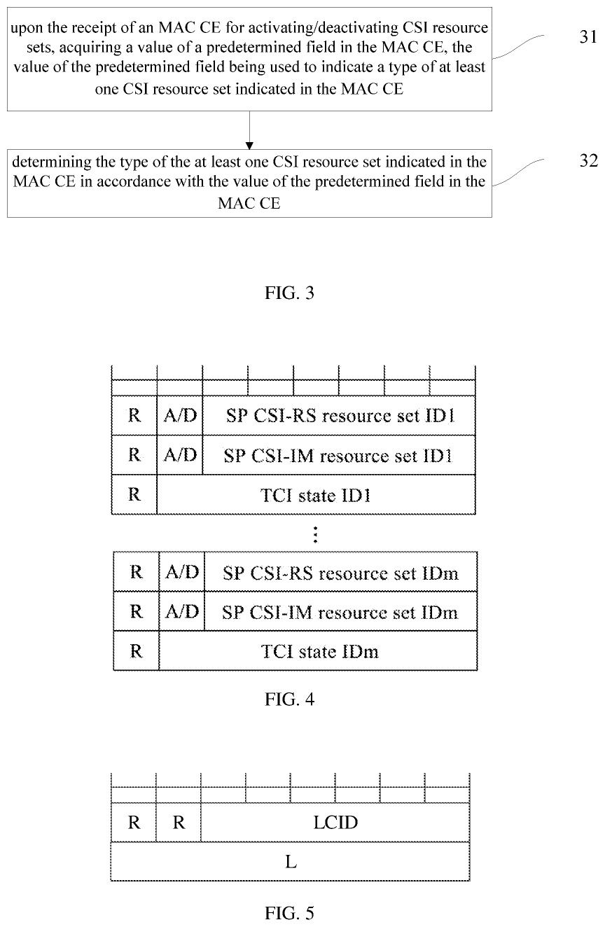

As shown in FIG. 3, the present disclosure further provides in some embodiments a method for determining a CSI resource type for a terminal, which includes: Step 31 of, upon the receipt of an MAC CE for activating/deactivating CSI resource sets, acquiring a value of a predetermined field in the MAC CE, the value of the predetermined field being used to indicate a type of at least one CSI resource set indicated in the MAC CE; and Step 32 of determining the type of the at least one CSI resource set indicated in the MAC CE in accordance with the value of the predetermined field in the MAC CE.

In a possible embodiment of the present disclosure, the predetermined field may be a field R in contents in the MAC CE, an activated/deactivated state of at least one CSI resource set may be indicated in the contents in the MAC CE, and each CSI resource set may correspond to one predetermined field.

As shown in FIG. 4, which shows the contents in the MAC CE for activating/deactivating the CSI resources, the MAC CE may be used to indicate activated/deactivated states of number m of CSI-RS resource sets and number m of CSI-IM resource sets. In FIG. 4, SP CSI-RS Resource Set ID is used to indicate a serial number of each CSI-RS resource set, and SP CSI-IM Resource Set ID is used to indicate a serial number of each CSI-IM resource set. Each CSI-RS resource set may correspond to one field R, and each CSI-IM resource set may correspond to one field R. The field R is used to indicate a type of a corresponding CSI resource set (a CSI-RS resource set or a CSI-IM resource set), i.e., where the CSI resource is a CSI resource set for a PUCCH or a CSI resource set for a PUSCH. A value of the field R may have one bit. When the value of the field R is 0, it means that the corresponding CSI resource set is a CSI resource set for the PUCCH, and when the value of the field R is 1, it means that the corresponding CSI resource set is a CSI resource set for the PUSCH; or when the value of the field R is 1, it means that the corresponding CSI resource set is a CSI resource set for the PUCCH, and when the value of the field R is 0, it means that the corresponding CSI resource set is a CSI resource set for the PUSCH.

In FIG. 4, a field A/D may be used to indicate an activated/deactivated state of an immediately-subsequent SP CSI-RS Resource Set ID or SP CSI-IM Resource Set ID. A value of the field A/D may also have one bit. When the value of the field A/D is 1, it means that the CSI resource is to be activated, and when the value of the field A/D is 0, it means that the CSI resource is to be deactivated; or when the value of the field A/D is 0, it means that the CSI resource is to be activated, and when the value of the field A/D is 1, it means that the CSI resource is to be deactivated. In some other embodiments of the present disclosure, the MAC CE may not include the field A/D, and all the CSI resource sets carried in the MAC CE may be activated or deactivated.

In a possible embodiment of the present disclosure, the predetermined field may be a logical channel identity (Logical Channel Identity, LCID) field in a header of the MAC CE, and a value of the LCID field in the header of the MAC CE may be used to indicate types of all the CSI resource sets indicated in the MAC CE.

As shown in FIG. 5, which shows the header of the MAC CE for activating/deactivating the CSI resources, in the embodiments of the present disclosure, the LCID field in the header of the MAC CE may be used to indicate the types of all the CSI resources sets indicated in the MAC CE.

In another possible embodiment of the present disclosure, the predetermined field may also be a field R in the header of the MAC CE, and a value of the field R in the header of the MAC CE may be used to indicate the types of all the CSI resource sets indicated in the MAC CE. A value of the field R may have one bit. When the value of the field R is 0, it means that all the CSI resource sets indicated in the MAC CE are for the PUCCH, and when the value of the field R is 1, it means that all the CSI resource sets indicated in the MAC CE are for the PUSCH; or when the value of the field R is 1, it means that all the CSI resource sets indicated in the MAC CE are for the PUCCH, and when the value of the field R is 0, it means that all the CSI resource sets indicated in the MAC CE are for the PUSCH.

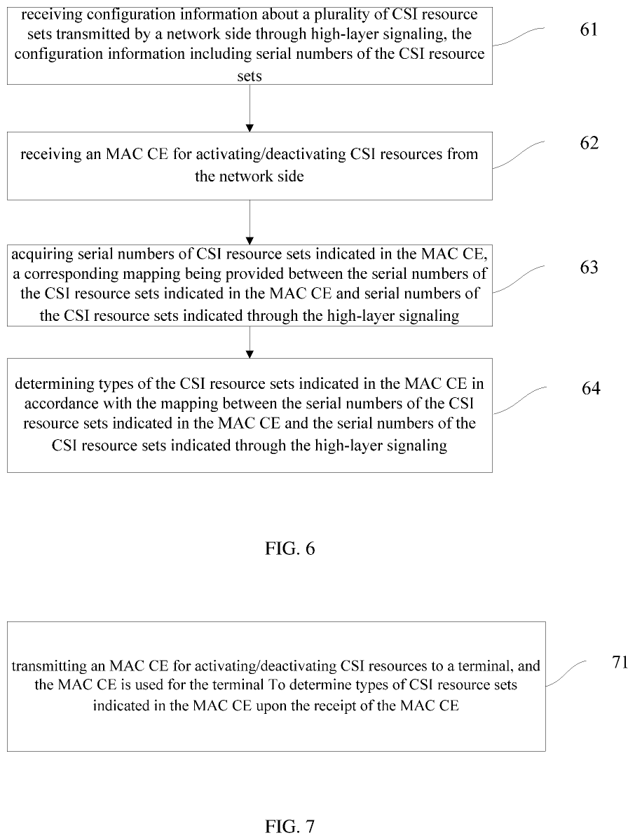

As shown in FIG. 6, the present disclosure further provides in some embodiments a method for determining a CSI resource type for a terminal, which includes the following steps.

Step 61: receiving configuration information about a plurality of CSI resource sets transmitted by a network side through high-layer signaling. The configuration information may include serial numbers of the CSI resource sets, and the plurality of CSI resource sets may include a first type of CSI resource sets and a second type of CSI resource sets.

Step 62: receiving an MAC CE for activating/deactivating CSI resources from the network side. The MAC CE may carry a serial number of a CSI resource set to be activated/deactivated.

Step 63: acquiring serial numbers of CSI resource sets indicated in the MAC CE. There is a corresponding mapping between the serial numbers of the CSI resource sets indicated in the MAC CE and serial numbers of the CSI resource sets indicated through the high-layer signaling.

Step 64: determining types of the CSI resource sets indicated in the MAC CE in accordance with the mapping between the serial numbers of the CSI resource sets indicated in the MAC CE and the serial numbers of the CSI resource sets indicated through the high-layer signaling.

In the embodiments of the present disclosure, the serial numbers of the CSI resource sets configured through the high-layer signaling may not be changed. Instead, the serial numbers of the CSI resource sets indicated in the MAC CE may be interpreted again, and the mapping between the serial numbers of the CSI resource sets configured through the high-layer signaling and the serial numbers of the CSI resource sets indicated in the MAC CE may be determined, so as to determine the types of the CSI resource sets indicated in the MAC CE in accordance with the mapping.

For example, when the quantity of CSI resource sets for a PUCCH is 16 at most and the quantity of CSI resource sets for a PUSCH is 16 at most, the CSI resource sets for the PUCCH and the CSI resource sets for the PUSCH may each numbered from 0 to 15. However, the CSI resource sets indicated in the MAC CE may be numbered from 0 to 31. In addition, the serial numbers 0 to 15 of the CSI resource sets indicated in the MAC CE may be mapped to the serial numbers 0 to 15 of the CSI resource sets for the PUCCH, and the serial numbers 16 to 31 of the CSI resource sets indicated in the MAC CE may be mapped to the serial numbers 0 to 15 of the CSI resource sets for the PUSCH. Of course, the serial numbers 0 to 15 of the CSI resource sets indicated in the MAC CE may also be mapped to the serial numbers 0 to 15 of the CSI resource sets for the PUSCH, and the serial numbers 16 to 31 of the CSI resource sets indicated in the MAC CE may also be mapped to the serial numbers 0 to 15 of the CSI resource sets for the PUCCH. Upon the receipt of the MAC CE, the terminal may determine the types of the CSI resource sets indicated in the MAC CE in accordance with the mapping.

The mapping may be predefined in a protocol or configured by the network side.

As shown in FIG. 7, the present disclosure further provides in some embodiments a method for activating/deactivating CSI resources for a network side device, which includes Step 71 of transmitting an MAC CE for activating/deactivating CSI resources to a terminal, and the MAC CE is used for the terminal to determine types of CSI resource sets indicated in the MAC CE upon the receipt of the MAC CE. The types of the CSI resource sets may include a first type for the measurement of a semi-persistent PUCCH and a second type for the measurement of a semi-persistent PUSCH.

In some embodiments of the present disclosure, prior to transmitting the MAC CE for activating/deactivating the CSI resources to the terminal, the method may further include transmitting configuration information about a plurality of CSI resource sets to the terminal through high-layer signaling. The configuration information may include serial numbers of the CSI resource sets. The plurality of CSI resource sets may include a first type of CSI resource sets and a second type of CSI resource sets. In the serial numbers of the CSI resource sets, the CSI resource sets including different CSI resources may have different serial numbers. The MAC CE may carry a serial number of a CSI resource set to be activated/deactivated, and the CSI resource sets indicated in the MAC CE may use a same numbering method as the CSI resource sets indicated through the high-layer signaling.

In some other embodiments of the present disclosure, the MAC CE may include a predetermined field, and a value of the predetermined field may be used to indicate a type of at least one CSI resource set indicated in the MAC CE.

In a possible embodiment of the present disclosure, the predetermined field may be a field R in contents in the MAC CE, an activated/deactivated state of at least one CSI resource set may be indicated in the contents in the MAC CE, and each CSI resource set may correspond to one predetermined field.

Alternatively, the predetermined field may be an LCID field or a field R in a header of the MAC CE, and a value of the LCID field or the field R in the header of the MAC CE may be used to indicate types of all the CSI resource sets indicated in the MAC CE.

In some other embodiments of the present disclosure, prior to transmitting the MAC CE for activating/deactivating the CSI resources to the terminal, the method may further include transmitting configuration information about a plurality of CSI resource sets to the terminal through high-layer signaling. The configuration information may include serial numbers of the CSI resource sets. The plurality of CSI resource sets may include a first type of CSI resource sets and a second type of CSI resource sets. The MAC CE may carry a serial number of a CSI resource set to be activated/deactivated, and there exists a corresponding mapping between the serial numbers of the CSI resource sets indicated in the MAC CE and the serial numbers of the CSI resource sets indicated through the high-layer signaling.

Each CSI resource may be a CSI-RS resource or a CSI-IM resource.

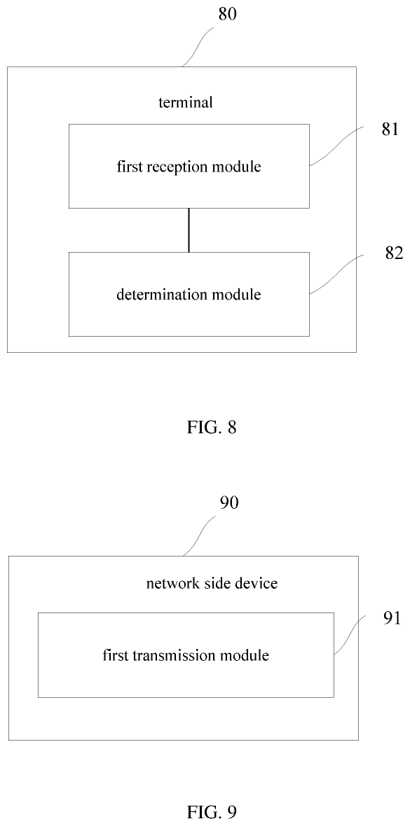

As shown in FIG. 8, the present disclosure further provides in some embodiments a terminal 80, which includes: a first reception module 81 configured to receive an MAC CE for activating/deactivating CSI resource sets; and a determination module 82 configured to determine types of the CSI resource sets indicated in the MAC CE, the types of the CSI resource sets including a first type for the measurement of a semi-persistent PUCCH and a second type for the measurement of a semi-persistent PUSCH.

In a possible embodiment of the present disclosure, the terminal may further include a second reception module configured to receive configuration information about a plurality of CSI resource sets transmitted by a network side through high-layer signaling. The configuration information may include serial numbers of the CSI resource sets. The plurality of CSI resource sets may include a first type of CSI resource sets and a second type of CSI resource sets. In the serial numbers of the CSI resource sets, the CSI resource sets including different CSI resources may have different serial numbers. The MAC CE may carry a serial number of a CSI resource set to be activated/deactivated. The determination module 82 is further configured to determine the types of the CSI resource sets indicated in the MAC CE in accordance with the serial numbers of the CSI resource sets indicated in the MAC CE and the serial numbers of the CSI resource sets indicated through the high-layer signaling. The CSI resource sets indicated in the MAC CE may use a same numbering method as the CSI resource sets indicated through the high-layer signaling.

In a possible embodiment of the present disclosure, the determination module may include: an acquisition sub-module configured to acquire a value of a predetermined field in the MAC CE, the value of the predetermined field being used to indicate a type of at least one CSI resource set indicated in the MAC CE; and an execution sub-module configured to determine the type of the at least one CSI resource set indicated in the MAC CE in accordance with the value of the predetermined field in the MAC CE.

In a possible embodiment of the present disclosure, the predetermined field may be a field R in contents in the MAC CE, an activated/deactivated state of at least one CSI resource set may be indicated in the contents in the MAC CE, and each CSI resource set may correspond to one predetermined field.

Alternatively, the predetermined field may be an LCID field or a field R in a header of the MAC CE, and a value of the LCID field or the field R in the header of the MAC CE may be used to indicate types of all the CSI resource sets indicated in the MAC CE.

In a possible embodiment of the present disclosure, the terminal may further include a third reception module configured to receive configuration information about a plurality of CSI resource sets transmitted by the network side through high-layer signaling. The configuration information may include serial numbers of the CSI resource sets, and the plurality of CSI resource sets may include a first type of CSI resource sets and a second type of CSI resource sets. The MAC CE may carry a serial number of a CSI resource set to be activated/deactivated. The determination module is further configured to: acquire the serial numbers of the CSI resource sets indicated in the MAC CE, a corresponding mapping being provided between the serial numbers of the CSI resource sets indicated in the MAC CE and the serial numbers of the CSI resource sets indicated through the high-layer signaling; and determine the types of the CSI resource sets indicated in the MAC CE in accordance with the mapping between the serial numbers of the CSI resource sets indicated in the MAC CE and the serial numbers of the CSI resource sets indicated through the high-layer signaling.

The mapping may be predefined in a protocol or configured by the network side.

Each CSI resource may be a CSI-RS resource or a CSI-IM resource.

As shown in FIG. 9, the present disclosure further provides in some embodiments a network side device 90, which includes a first transmission module 91 configured to transmit an MAC CE for activating/deactivating CSI resources to a terminal, and the MAC CE is used for the terminal to determine types of CSI resource sets indicated in the MAC CE upon the receipt of the MAC CE. The types of the CSI resource sets may include a first type for the measurement of a semi-persistent PUCCH and a second type for the measurement of a semi-persistent PUSCH.

In a possible embodiment of the present disclosure, the network side device may further include a second transmission module configured to transmit configuration information about a plurality of CSI resource sets to the terminal through high-layer signaling. The configuration information may include serial numbers of the CSI resource sets. The plurality of CSI resource sets may include a first type of CSI resource sets and a second type of CSI resource sets. In the serial numbers of the CSI resource sets, the CSI resource sets including different CSI resources may have different serial numbers. The MAC CE may carry a serial number of a CSI resource set to be activated/deactivated, and the CSI resource sets indicated in the MAC CE may use a same numbering method as the CSI resource sets indicated through the high-layer signaling.

In some other embodiments of the present disclosure, the MAC CE may include a predetermined field, and a value of the predetermined field may be used to indicate a type of at least one CSI resource set indicated in the MAC CE.

In a possible embodiment of the present disclosure, the predetermined field may be a field R in contents in the MAC CE, an activated/deactivated state of at least one CSI resource set may be indicated in the contents in the MAC CE, and each CSI resource set may correspond to one predetermined field.

Alternatively, the predetermined field may be an LCID field or a field R in a header of the MAC CE, and a value of the LCID field or the field R in the header of the MAC CE may be used to indicate types of all the CSI resource sets indicated in the MAC CE.

In a possible embodiment of the present disclosure, the network side device may further include a third transmission module configured to transmit configuration information about a plurality of CSI resource sets to the terminal through high-layer signaling. The configuration information may include serial numbers of the CSI resource sets. The plurality of CSI resource sets may include a first type of CSI resource sets and a second type of CSI resource sets. The MAC CE may carry a serial number of a CSI resource set to be activated/deactivated, and there exists a corresponding mapping between the serial numbers of the CSI resource sets indicated in the MAC CE and the serial numbers of the CSI resource sets indicated through the high-layer signaling.

The mapping may be predefined in a protocol or configured by the network side device.

Each CSI resource may be a CSI-RS resource or a CSI-IM resource.

The present disclosure further provides in some embodiments a terminal, which includes a processor, a memory, and a computer program stored in the memory and executed by the processor. The processor is configured to execute the computer program so as to implement the above-mentioned method for determining the CSI resource type.

The present disclosure further provides in some embodiments a network side device, which includes a processor, a memory, and a computer program stored in the memory and executed by the processor. The processor is configured to execute the computer program so as to implement the above-mentioned method for activating/deactivating CSI resources.

The present disclosure further provides in some embodiments a computer-readable storage medium storing therein a computer program. The computer program is executed by a processor so as to implement the above-mentioned method for determining the CSI resource type, or implement the above-mentioned method for activating/deactivating the CSI resources. The computer-readable storage medium may be a read-only memory (Read-Only Memory, ROM), a random access memory (Random Access Memory, RAM), a magnetic disk or an optical disk.

The schemes in the above embodiments of the present disclosure are used to determine whether the CSI resource set indicated in the MAC CE for activating/deactivating the CSI resources is a CSI resource set for the PUCCH or a CSI resource set for the PUSCH.

According to a conclusion on new radio (New Radio, NR) in the related art, a semi-persistent SRS has an activation/deactivation function, which may be achieved through the MAC CE. The MAC CE for activating/deactivating the semi-persistent SRS may indicate an activated/deactivated state of at least one SRS resource set. Reference signal types of QCL-related information about the SRS resource sets may include CSI-RS, SSB and SRS, so there is an urgent need to provide a scheme for determining the reference signal types of the QCL-related information about the SRS resource sets. QCL may be used to represent a spatial relationship.

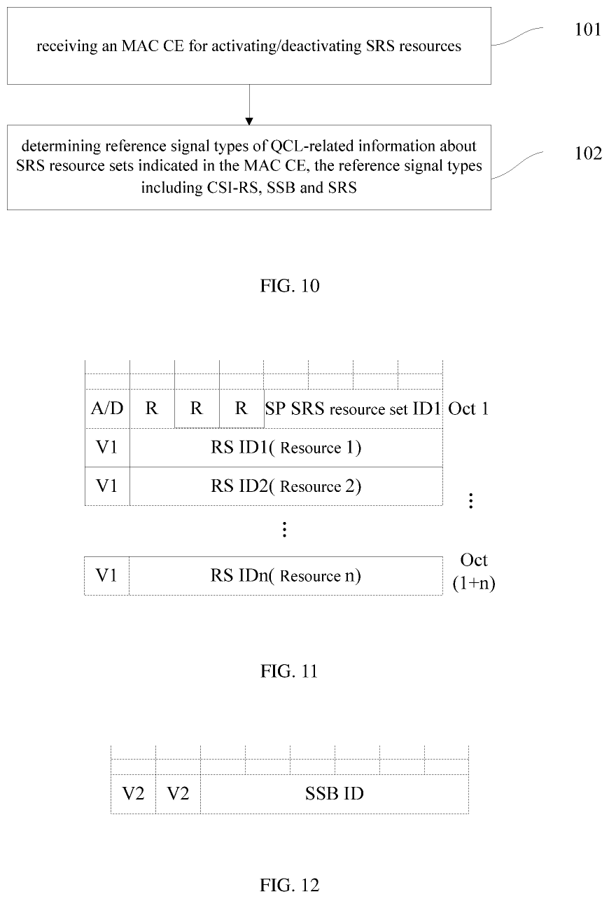

As shown in FIG. 10, the present disclosure further provides in some embodiments a method for determining reference signal types of SRS resources for a terminal, which includes: Step 101 of receiving an MAC CE for activating/deactivating the SRS resources; and Step 102 of determining reference signal types of QCL-related information about SRS resource sets indicated in the MAC CE, the reference signal types including CSI-RS, SSB and SRS.

In the embodiments of the present disclosure, an activated/deactivated state of at least one SRS resource set may be indicated in the MAC CE for activating/deactivating (activating or deactivating) the SRS resource sets, and each SRS resource set may include one or more SRS resources.

In the embodiments of the present disclosure, upon the receipt of the MAC CE for activating/deactivating the SRS resource sets, the reference signal types of the QCL-related information about the SRS resource set indicated in the MAC CE may be determined, so as to determine an accurate reference signal for the SRS resource set.

In a possible embodiment of the present disclosure, the determining the reference signal types of the QCL-related information about the SRS resource sets indicated in the MAC CE may include: acquiring a value of a predetermined field in the MAC CE, the value of the predetermined field being used to indicate the reference signal types of the QCL-related information about at least one SRS resource set indicated in the MAC CE; and determining the reference signal types of the QCL-related information about the at least one SRS resource set indicated in the MAC CE in accordance with the value of the predetermined field in the MAC CE.

In a possible embodiment of the present disclosure, the predetermined field may include a field V1 in contents in the MAC CE, an activated/deactivated state of at least one SRS resource set may be indicated in the MAC CE, and each SRS resource set may correspond to one field V1. When the field V1 has a first value, it means that the reference signal type of the QCL-related information about a corresponding SRS resource set is CSI-RS, and when the field V1 has a second value, it means that the reference signal type of the QCL-related information about the corresponding SRS resource set is SSB or SRS.

The predetermined field may further include a field V2 in the contents in the MAC CE, and a value of the field V2 may be used to indicate that the reference signal type of the QCL-related information about the corresponding SRS resource set is SSB or SRS.

As shown in FIG. 11, which shows the contents in the MAC CE for activating/deactivating the SRS resources, SP SRS Resource Set ID1 is used to indicate a serial number of an SRS resource set to be activated/deactivated, and RSID is used to indicate a serial number of a reference signal of the QCL-related information about the SRS resource set. Each reference signal may correspond to one field V1. For example, when the value of the field V1 is 1, it means that a corresponding reference signal is CSI-RS, and when the value of the field V1 is 0, it means that the corresponding reference signal is SSB or SRS; or when the value of the field V1 is 0, it means that the corresponding reference signal is CSI-RS, and when the value of the field V1 is 1, it means that the corresponding reference signal is SSB or SRS.

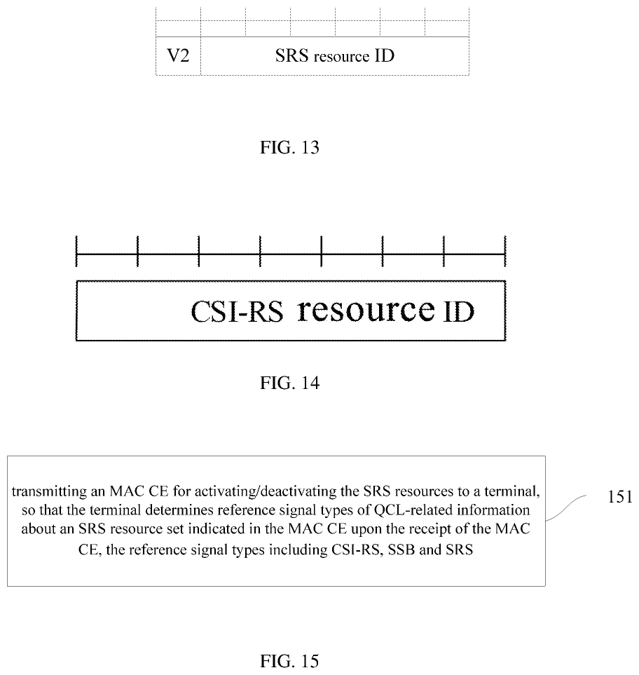

Further, as shown in FIGS. 12 to 14, the contents in the MAC CE for activating/deactivating the SRS resources may include a field V2, and a value of the field V2 may be used to indicate that the reference signal type of the QCL-related information about the corresponding SRS resource set is SSB or SRS. For example, when the value of the field V2 is 0, it means that the corresponding reference signal is SSB, and when the value of the field V2 is 1, it means that the corresponding reference signal is SRS; or when the value of the field V2 is 1, it means that the corresponding reference signal is SSB, and when the value of the field V2 is 0, it means that the corresponding reference signal is SRS.

As shown in FIG. 15, the present disclosure further provides in some embodiments a method for activating/deactivating SRS resources for a network side device, which includes Step 151 of transmitting an MAC CE for activating/deactivating the SRS resources to a terminal, and the MAC CE is used for the terminal to determine reference signal types of QCL-related information about an SRS resource set indicated in the MAC CE upon the receipt of the MAC CE. The reference signal types may include CSI-RS, SSB and SRS.

In a possible embodiment of the present disclosure, the MAC CE may include a predetermined field, and a value of the predetermined field may be used to indicate the reference signal type of the QCL-related information about at least one SRS resource set indicated in the MAC CE.

In a possible embodiment of the present disclosure, the predetermined field may include a field V1 in contents in the MAC CE, an activated/deactivated state of at least one SRS resource set may be indicated in the MAC CE, and each SRS resource set may correspond to one field V1. When the field V1 has a first value, it means that the reference signal type of the QCL-related information about a corresponding SRS resource set is CSI-RS, and when the field V1 has a second value, it means that the reference signal type of the QCL-related information about the corresponding SRS resource set is SSB or SRS.

In a possible embodiment of the present disclosure, the predetermined field may further include a field V2 in the contents in the MAC CE, and a value of the field V2 may be used to indicate that the reference signal type of the QCL-related information about the corresponding SRS resource set is SSB or SRS.

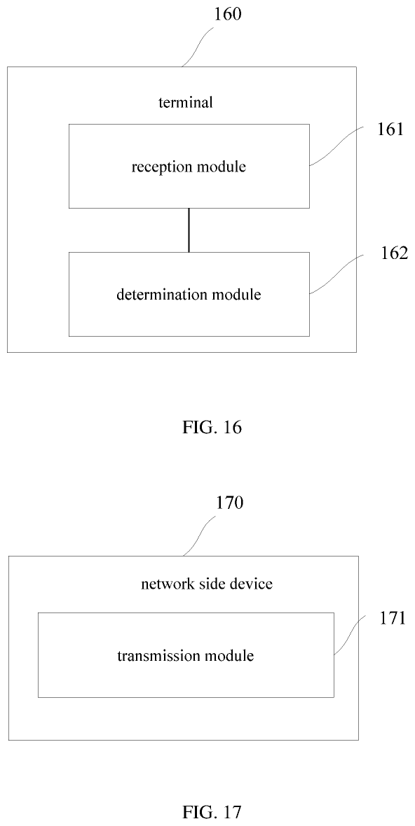

As shown in FIG. 16, the present disclosure further provides in some embodiments a terminal 160, which includes: a reception module 161 configured to receive an MAC CE for activating/deactivating the SRS resources; and a determination module 162 configured to determine reference signal types of QCL-related information about an SRS resource set indicated in the MAC CE, the reference signal types including CSI-RS, SSB and SRS.

In a possible embodiment of the present disclosure, the determination module 162 is further configured to: acquire a value of a predetermined field in the MAC CE, the value of the predetermined field being used to indicate the reference signal types of the QCL-related information about at least one SRS resource set indicated in the MAC CE; and determine the reference signal types of the QCL-related information about the at least one SRS resource set indicated in the MAC CE in accordance with the value of the predetermined field in the MAC CE.

In a possible embodiment of the present disclosure, the predetermined field may include a field V1 in contents in the MAC CE, an activated/deactivated state of at least one SRS resource set may be indicated in the MAC CE, and each SRS resource set may correspond to one field V1. When the field V1 has a first value, it means that the reference signal type of the QCL-related information about a corresponding SRS resource set is CSI-RS, and when the field V1 has a second value, it means that the reference signal type of the QCL-related information about the corresponding SRS resource set is SSB or SRS.

In a possible embodiment of the present disclosure, the predetermined field may further include a field V2 in the contents in the MAC CE, and a value of the field V2 may be used to indicate that the reference signal type of the QCL-related information about the corresponding SRS resource set is SSB or SRS.

As shown in FIG. 17, the present disclosure further provides in some embodiments a network side device 170, which includes a transmission module configured to transmit an MAC CE for activating/deactivating SRS resources to a terminal, and the MAC CE is used for the terminal to determine reference signal types of QCL-related information about an SRS resource set indicated in the MAC CE upon the receipt of the MAC CE. The reference signal types may include CSI-RS, SSB and SRS.

In a possible embodiment of the present disclosure, the MAC CE may include a predetermined field, and a value of the predetermined field may be used to indicate the reference signal type of the QCL-related information about at least one SRS resource set indicated in the MAC CE.

In a possible embodiment of the present disclosure, the predetermined field may include a field V1 in contents in the MAC CE, an activated/deactivated state of at least one SRS resource set may be indicated in the MAC CE, and each SRS resource set may correspond to one field V1. When the field V1 has a first value, it means that the reference signal type of the QCL-related information about a corresponding SRS resource set is CSI-RS, and when the field V1 has a second value, it means that the reference signal type of the QCL-related information about the corresponding SRS resource set is SSB or SRS.

In a possible embodiment of the present disclosure, the predetermined field may further include a field V2 in the contents in the MAC CE, and a value of the field V2 may be used to indicate that the reference signal type of the QCL-related information about the corresponding SRS resource set is SSB or SRS.

The present disclosure further provides in some embodiments a terminal, which includes a processor, a memory, and a computer program stored in the memory and executed by the processor. The processor is configured to execute the computer program so as to implement the above-mentioned method for determining the reference signal types of the SRS resources.

The present disclosure further provides in some embodiments a network side device, which includes a processor, a memory, and a computer program stored in the memory and executed by the processor. The processor is configured to execute the computer program so as to implement the above-mentioned method for activating/deactivating the SRS resources.

The present disclosure further provides in some embodiments a computer-readable storage medium storing therein a computer program. The computer program is executed by a processor so as to implement the above-mentioned method for determining the reference signal types of the SRS resources, or implement the above-mentioned method for activating/deactivating the SRS resources. The computer-readable storage medium may be an ROM, an RAM, a magnetic disk or an optical disk.

The above-mentioned methods and devices may be applied to a 5^{th}-generation (5^{th}-Generation, 5G) system, a long term evolution (Long Term Evolution, LTE) communications system, or any other future communications systems.

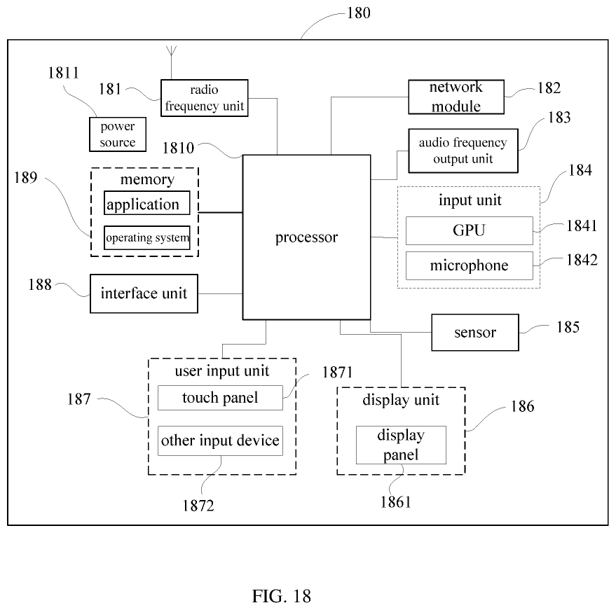

FIG. 18 shows a hardware structure of a mobile terminal according to one embodiment of the present disclosure. The mobile terminal 180 may include, but not limited to, a radio frequency unit 181, a network module 182, an audio frequency output unit 183, an input unit 184, a sensor 185, a display unit 186, a user input unit 187, an interface unit 188, a memory 189, a processor 1810, and a power source 1811. It should be appreciated that, the structure in FIG. 18 shall not be construed as limiting the mobile terminal. The mobile terminal may include more or fewer members, or some members may be combined, or the members may be arranged in different modes. In the embodiments of the present disclosure, the mobile terminal may include, but not limited to, mobile phone, flat-panel computer, laptop computer, personal digital assistant, vehicle-mounted terminal, wearable device or pedometer.

The radio frequency unit 181 is configured to receive an MAC CE for activating/deactivating CSI resource sets, the processor 1810 is configured to determine types of the CSI resource sets indicated in the MAC CE, and the types of the CSI resource sets may include a first type for the measurement of a semi-persistent PUCCH and a second type for the measurement of a semi-persistent PUSCH. Alternatively, the radio frequency unit 181 is configured to receive an MAC CE for activating/deactivating the SRS resources, the processor 1810 is configured to determine reference signal types of QCL-related information about an SRS resource set indicated in the MAC CE, and the reference signal types may include CSI-RS, SSB and SRS.

It should be further appreciated that, in the embodiments of the present disclosure, the radio frequency unit 181 is configured to transmit and receive signals during the information transmission or phone call. To be specific, the radio frequency unit 181 may, upon the receipt of downlink data from a base station, transmit the downlink data to the processor 1810 for subsequent treatment. In addition, the radio frequency unit 181 may transmit uplink data to the base station. Usually, the radio frequency unit 181 may include, but not limited to, an antenna, at least one amplifier, a transceiver, a coupler, a low-noise amplifier and a duplexer. In addition, the radio frequency unit 181 may communicate with a network and the other devices via a wireless communications system.

The network module 182 is configured to enable a user to access the broadband Internet in a wireless manner, e.g., help the user to receive and send an e-mail, browse a web or access a streaming media.

The audio frequency output unit 183 is configured to convert audio data received by the radio frequency unit 181 or the network module 182, or audio data stored in the memory 189, into an audio signal and output the audio signal as a sound. In addition, the audio output unit 183 is further configured to provide an audio output related to a specific function executed by the mobile terminal 180 (e.g., a sound occurring when a calling signal or a message has been received). The audio frequency output unit 183 may include a loudspeaker, a buzzer and a receiver.

The input unit 184 is configured to receive an audio or video signal. It may include a graphics processing unit (Graphics Processing Unit, GPU) 1841 and a microphone 1842. The GPU 1841 is configured to process image data of a static image or video acquired by an image collection unit (e.g., a camera) in a video capturing mode or an image capturing mode, and a processed image frame may be displayed by the display unit 186. The image frame processed by the GPU 1841 may be stored in the memory 189 (or any other storage medium) or transmitted via the radio frequency unit 181 or network module 182. The microphone 1842 is configured to receive a sound, and convert the sound into voice data. In a call mode, the processed audio data may be converted into data in a format capable of being transmitted by the radio frequency unit 181 to a mobile communication base station.

The at least one sensor 185 may include a light sensor, a movement sensor and the other sensors. To be specific, the light sensor may include an ambient light sensor or a proximity sensor. The ambient light sensor is configured to adjust a brightness value of a display panel 1861 in accordance with ambient light. The proximity sensor is configured to turn off the display panel 1861 and/or a backlight source. As one of the movement sensors, an accelerometer may detect acceleration in various directions (usually a three-axis accelerometer), and detect a level and a direction of a gravity force when in a static state. Through the accelerometer, it is able to identify a posture of the electronic device (e.g., perform a switching operation between portrait and landscape orientations, play relevant games, and calibrate a posture of a magnetometer), and perform vibration-related functions (e.g., count steps and strikes). The sensor 185 may further include a fingerprint sensor, a pressure sensor, an iris sensor, a molecule sensor, a gyroscope, a barometer, a hygrometer, a thermometer or an infrared sensor, which will not be particularly defined herein.

The display unit 186 is configured to display information inputted by the user or provided to the user. The display unit 186 may include the display panel 1861, e.g., a Liquid Crystal Display (LCD) panel, or an Organic Light-Emitting Diode (OLED) panel.

The user input unit 187 is configured to receive digital or character information inputted by the user, and generate a key signal input related to user settings and function control of the mobile terminal. To be specific, the user input unit 187 may include a touch panel 1871 and an input device 1872. The touch panel 1871, also called as touch screen, is configured to collect a touch operation made by the user on or in proximity to the touch panel (e.g., an operation made by the user through any appropriate object or attachment (e.g., finger or stylus) on or in the proximity to the touch panel 1871). The touch panel 1871 may include a touch detection unit and a touch controller. The touch detection unit is configured to detect a touch position and a signal generated due to the touch operation, and transmit the signal to the touch controller. The touch controller is configured to receive touch information from the touch detection unit, convert it into coordinates of a touch point, transmit the coordinates to the processor 1810, and receive and execute a command from the processor 1810. In addition, the touch panel 1871 may be of a resistive type, a capacitive type, an infrared type or a surface acoustic wave (SAW) type. The other input device 1872 may include, but not limited to, a physical keyboard, a functional button (e.g., a volume control button or an on/off button), a trackball, a mouse, and a joystick, which will not be particularly defined herein.

Further, the touch panel 1871 may cover the display panel 1861. When the touch operation made on or in proximity to the touch panel 14071 has been detected, the touch panel 1871 may transmit the touch information to the processor 1810, so as to determine a type of a touch event. Then, the processor 1810 may control the display panel 1861 to provide a corresponding visual output in accordance with the type of the touch event. Although the touch panel 1871 and the display panel 1861 are configured as two separate members in FIG. 18, in some embodiments of the present disclosure, they may be integrated so as to achieve the input and output functions of the mobile terminal, which will not be particularly defined herein.

The interface unit 188 is configured to provide an interface between an external device and the mobile terminal 180. For example, the external device may include a wired or wireless headset port, an external power source port (or a charging port), a wired or wireless data port, a memory card port, a port for a device having an identification module, an audio input/output (I/O) port, a video I/O port, and an earphone port. The interface unit 188 is configured to receive an input from the external device (e.g., data information and electricity) and transmit the input to one or more elements of the mobile terminal 180, or transmit data between the mobile terminal 180 and the external device.

The memory 189 is configured to store therein a software application and various data. It may mainly include an application storage area and a data storage area. An operating system and at least one application for the functions (e.g., an audio/image playing function) may be stored in the application storage area. Data created in accordance with the operation of the mobile phone (e.g., audio data and textbook) may be stored in the data storage area. In addition, the memory 189 may include a high-speed random access memory, or a non-volatile memory (e.g., at least one magnetic disk or flash memory), or any other volatile solid state memory.

As a control center of the mobile terminal, the processor 1810 may be connected to the other members of the mobile terminal via various interfaces and circuits, and configured to run or execute the software program and/or module stored in the memory 189, and call the data stored in the memory 189, so as to execute the functions of the mobile terminal and process the data, thereby to monitor the entire mobile terminal. The processor 1810 may include one or more processing units. In a possible embodiment of the present disclosure, an application processor and a modem may be integrated into the processor 1810. The application processor is mainly configured to process the operating system, a user interface and the application. The modem is mainly configured to process wireless communication. It should be appreciated that, the modem may also not be integrated into the processor 1810.

The power source 1811 (e.g., a battery) is configured to supply power to the members of the mobile terminal 180. In a possible embodiment of the present disclosure, the power source 1811 is logically connected to the processor 1810 via a power source management system, so as to achieve such functions as charging, discharging and power consumption management through the power source management system.

In addition, the mobile terminal 180 may include some functional modules not shown in FIG. 18, which will not be particularly defined herein.

The terminal in the embodiments of the present disclosure may be a wireless terminal or a wired terminal. The wireless terminal may be a device capable of providing voice data and/or any other service data to a user, e.g., a handheld device having a wireless connection function, or any other processing device capable of being connected to a wireless modem. The wireless terminal may communicate with one or more core networks via a radio access network (Radio Access Network, RAN). The wireless terminal may be a mobile terminal, e.g., a mobile phone (or cellular phone), or a computer having the mobile terminal, e.g., a portable, pocket-sized, handheld, built-in or vehicle-mounted mobile device, which are capable of exchanging voice and/or data with the RAN. For example, the wireless terminal may be a personal communication service (Personal Communication Service, PCS) telephone, a cordless telephone, a session initiation protocol (Session Initiation Protocol, SIP) phone, a wireless local loop (Wireless Local Loop, WLL) station, or a personal digital assistant (Personal Digital Assistant, PDA). In addition, the wireless terminal may also be called as system, subscriber unit, subscriber station, mobile station, mobile, remote station, remote terminal, access terminal, user terminal, user agent, user device or user equipment, which will not be particularly defined herein.

The network side device in the embodiments of the present disclosure may be a base transceiver station (Base Transceiver Station, BTS) in a global system of mobile communication (Global System of Mobile Communication, GSM) or a code division multiple access (Code Division Multiple Access, CDMA) system, a node B (Node B, NB) in a wideband code division multiple access (Wideband Code Division Multiple Access, WCDMA) system, an evolved node B (Evolved Node B, eNB or eNodeB) in an LTE system, a relay or an access point, or a base station in a 5G network, which will not be particularly defined herein.

It should be appreciated that, such words as “include” or “including” or any other variations involved in the present disclosure intend to provide non-exclusive coverage, so that a procedure, method, article or device including a series of elements may also include any other elements not listed herein, or may include any inherent elements of the procedure, method, article or device. If without any further limitations, for the elements defined by such sentence as “including one . . . ”, it is not excluded that the procedure, method, article or device including the elements may also include any other identical elements.

Through the above-mentioned description, it may be apparent for a person skilled in the art that the present disclosure may be implemented by software as well as a necessary common hardware platform, or by hardware, and the former may be better in most cases. Based on this, the technical solutions of the present disclosure, partial or full, or parts of the technical solutions of the present disclosure contributing to the related art, may appear in the form of software products, which may be stored in a storage medium (e.g., ROM/RAM, magnetic disk or optical disk) and include several instructions so as to enable a terminal device (mobile phone, computer, server, air conditioner or network device) to execute the method in the embodiments of the present disclosure.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1-18. (canceled)

19. A method for determining reference signal types of sounding reference signal (SRS) resources for a terminal, comprising:
receiving a media access control control element (MAC CE) for activating/deactivating the SRS resources; and
determining reference signal types of quasi-co-location (QCL)-related information about SRS resource sets indicated in the MAC CE, the reference signal types comprising channel state information-reference signal (CSI-RS), synchronization signal block (SSB) and SRS.

20. The method according to claim 19, wherein the determining the reference signal types of the QCL-related information about the SRS resource sets indicated in the MAC CE comprises:
acquiring a value of a predetermined field in the MAC CE, the value of the predetermined field being used to indicate the reference signal types of the QCL-related information about at least one SRS resource set indicated in the MAC CE; and
determining the reference signal types of the QCL-related information about the at least one SRS resource set indicated in the MAC CE in accordance with the value of the predetermined field in the MAC CE.

21. The method according to claim 20, wherein the predetermined field comprises a field V1 in contents in the MAC CE, an activated/deactivated state of at least one SRS resource set is indicated in the MAC CE, and each SRS resource set corresponds to one field V1,
wherein when the field V1 has a first value, the reference signal type of the QCL-related information about a corresponding SRS resource set is CSI-RS, and when the field V1 has a second value, the reference signal type of the QCL-related information about the corresponding SRS resource set is SSB or SRS.

22. The method according to claim 21, wherein the predetermined field further comprises a field V2 in the contents in the MAC CE, and a value of the field V2 is used to indicate that the reference signal type of the QCL-related information about the corresponding SRS resource set is SSB or SRS.

23. A method for activating/deactivating sounding reference signal (SRS) resources for a network side device, comprising:
transmitting a media access control control element (MAC CE) for activating/deactivating the SRS resources to a terminal, and the MAC CE is used for the terminal to determine reference signal types of quasi-co-location (QCL)-related information about SRS resource sets indicated in the MAC CE upon the receipt of the MAC CE,
wherein the reference signal types comprise channel state information-reference signal (CSI-RS), synchronization signal block (SSB) and SRS.

24. The method according to claim 23, wherein the MAC CE comprises a predetermined field, and a value of the predetermined field is used to indicate the reference signal type of the QCL-related information about at least one SRS resource set indicated in the MAC CE.

25. The method according to claim 24, wherein the predetermined field comprises a field V1 in contents in the MAC CE, an activated/deactivated state of at least one SRS resource set is indicated in the MAC CE, and each SRS resource set corresponds to one field V1,
wherein when the field V1 has a first value, the reference signal type of the QCL-related information about a corresponding SRS resource set is CSI-RS, and when the field V1 has a second value, the reference signal type of the QCL-related information about the corresponding SRS resource set is SSB or SRS.

26. The method according to claim 25, wherein the predetermined field further comprises a field V2 in the contents in the MAC CE, and a value of the field V2 is used to indicate that the reference signal type of the QCL-related information about the corresponding SRS resource set is SSB or SRS.

27-30. (canceled)

31. A terminal, comprising a processor, a memory, and a computer program stored in the memory and executed by the processor, wherein the processor is configured to execute the computer program so as to implement a method for determining reference signal types of sounding reference signal (SRS) resources for the terminal, comprising:
receiving a media access control control element (MAC CE) for activating/deactivating the SRS resources; and
determining reference signal types of quasi-co-location (QCL)-related information about SRS resource sets indicated in the MAC CE, the reference signal types comprising channel state information-reference signal (CSI-RS), synchronization signal block (SSB) and SRS.

32. A network side device, comprising a processor, a memory, and a computer program stored in the memory and executed by the processor, wherein the processor is configured to execute the computer program so as to implement the method for activating/deactivating the SRS resources according to claim 23.

33. A computer-readable storage medium storing therein a computer program, wherein the computer program is executed by a processor, so as to implement the method for determining the reference signal types of the SRS resources according to claim 19.

34. A computer-readable storage medium storing therein a computer program, wherein the computer program is executed by a processor, so as to implement the method for activating/deactivating the SRS resources according to claim 23.

35. The terminal according to claim 31, wherein the determining the reference signal types of the QCL-related information about the SRS resource sets indicated in the MAC CE comprises:
acquiring a value of a predetermined field in the MAC CE, the value of the predetermined field being used to indicate the reference signal types of the QCL-related information about at least one SRS resource set indicated in the MAC CE; and
determining the reference signal types of the QCL-related information about the at least one SRS resource set indicated in the MAC CE in accordance with the value of the predetermined field in the MAC CE.

36. The terminal according to claim 35, wherein the predetermined field comprises a field V1 in contents in the MAC CE, an activated/deactivated state of at least one SRS resource set is indicated in the MAC CE, and each SRS resource set corresponds to one field V1,
wherein when the field V1 has a first value, the reference signal type of the QCL-related information about a corresponding SRS resource set is CSI-RS, and when the field V1 has a second value, the reference signal type of the QCL-related information about the corresponding SRS resource set is SSB or SRS.

37. The terminal according to claim 36, wherein the predetermined field further comprises a field V2 in the contents in the MAC CE, and a value of the field V2 is used to indicate that the reference signal type of the QCL-related information about the corresponding SRS resource set is SSB.

38. The terminal according to claim 36, wherein the predetermined field further comprises a field V2 in the contents in the MAC CE, and a value of the field V2 is used to indicate that the reference signal type of the QCL-related information about the corresponding SRS resource set is SRS.

39. The network side device according to claim 32, wherein the MAC CE comprises a predetermined field, and a value of the predetermined field is used to indicate the reference signal type of the QCL-related information about at least one SRS resource set indicated in the MAC CE.

40. The network side device according to claim 39, wherein the predetermined field comprises a field V1 in contents in the MAC CE, an activated/deactivated state of at least one SRS resource set is indicated in the MAC CE, and each SRS resource set corresponds to one field V1,
wherein when the field V1 has a first value, the reference signal type of the QCL-related information about a corresponding SRS resource set is CSI-RS, and when the field V1 has a second value, the reference signal type of the QCL-related information about the corresponding SRS resource set is SSB or SRS.

41. The network side device according to claim 40, wherein the predetermined field further comprises a field V2 in the contents in the MAC CE, and a value of the field V2 is used to indicate that the reference signal type of the QCL-related information about the corresponding SRS resource set is SSB.

42. The network side device according to claim 40, wherein the predetermined field further comprises a field V2 in the contents in the MAC CE, and a value of the field V2 is used to indicate that the reference signal type of the QCL-related information about the corresponding SRS resource set is SRS.
